(19) United States
(12) Patent Application Publication
(10) Pub. No.: US 2009/0100091 A1
(43) Pub. Date: Apr. 16, 2009

(54) METHOD AND SYSTEM FOR PROVIDING A PROCESS OBJECT FRAMEWORK FOR PROCESSING A REQUEST-TYPE PROCESS

(76) Inventors: SRIKANTH CHANDRU, Bangalore (IN); Puspen Chattopadhyay, Durgapur (IN)

Correspondence Address: SAP AG, 3410 HILLVIEW AVENUE, PALO ALTO, CA, 94304, US

(21) Appl. No.: 11/872,049

(22) Filed: Oct. 15, 2007

(51) Int. Cl. G06F 7/00

(52) U.S. Cl. 707/103 Y; 707/E17.055

(57) ABSTRACT

Disclosed is a method and system for creating a process object that represents a request-type process of a first application, receiving data from the request-type process into the process object creating a process data contained in the process object and processing the request-type process by executing steps of the request-type process on the process data. The process data contained in the process object is converted to a storage format and a database is updated with the process data.

### FIELD OF THE INVENTION

The invention generally relates to the field of shared services application and more specifically to processing a request-type process of the shared services application.

### BACKGROUND OF THE INVENTION

A request-type process of an application that follows a pattern having various steps like request-process-approve-complete typically does not have a comprehensive framework which can provide a generalized access and storage of different types of data such as attributes, documents, structured data containers, and comments captured during the different steps of the process. It is typically tedious, error-prone and time-consuming involving the application to manually identify and make calls to complex application programming interfaces (APIs) of a database.

For example, a request-type process such as a birth of a child process, is a simple two-step process consisting of request and process steps, involving two roles, an employee and a human resource representative in each step respectively. The process involves only one interactive user interface (UI) which is filled by the employee. The birth of a child process supports the notification relating to the birth of a child that an employee can initiate.

Existing frameworks for implementing such a scenario typically has certain limitations such as:
No support for step-specific attributes and application-specific attributes for a process
Cannot store step-specific data entered in a user interface (UI) as well as different versions of the data entered in the UI
Cannot store structured-data such as a before-image and after-image of master data during persistence of process data
No support to store attachments uploaded in different steps
No support for application-specific data storage

A complex process which involves data entry into multiple interactive UIs spread over many steps typically does not support data mapping and sharing of attachments in all subsequent steps of the process. To achieve all the above, the application could directly make calls to the very technical low-level APIs of a database or any other application which stores data in a structured format. Every call to the database consumes a significant amount of time and resource and therefore they are less efficient. The parameters involved to call a method are complex to comprehend. Also, there is a need for developing more request-type processes in every domain with increasing demand of shared-services application.

### SUMMARY OF THE INVENTION

What is described is a method and system for creating a process object that represents a request-type process of a first application, receiving data from the request-type process into the process object creating a process data contained in the process object and processing the request-type process by executing steps of the request-type process on the process data. The process data contained in the process object is converted to a storage format and a database is updated with the process data.

### BRIEF DESCRIPTION OF THE DRAWINGS

FIG. 1 is a flow diagram for processing a request-type process using a process object framework according to an embodiment of the invention.

FIG. 2 is a flow diagram for a birth of a child process according to an embodiment of the invention.

FIG. 3 is a block diagram of various layers of a process object framework according to an embodiment of the invention.

FIG. 4 is a flow diagram for an employee loan application process according to an embodiment of the invention.

FIG. 5 is a block diagram for integrating request-type process of applications using a process object framework according to an embodiment of the invention.

FIG. 6 is a block diagram of various components of a process object framework for processing a request-type process of an application according to an embodiment of the invention.

### DETAILED DESCRIPTION

What is described is a method and system for creating a process object that represents a request-type process of a first application, receiving data from the request-type process into the process object creating a process data contained in the process object and processing the request-type process by executing steps of the request-type process on the process data. The process data contained in the process object is converted to a storage format and a database is updated with the process data.

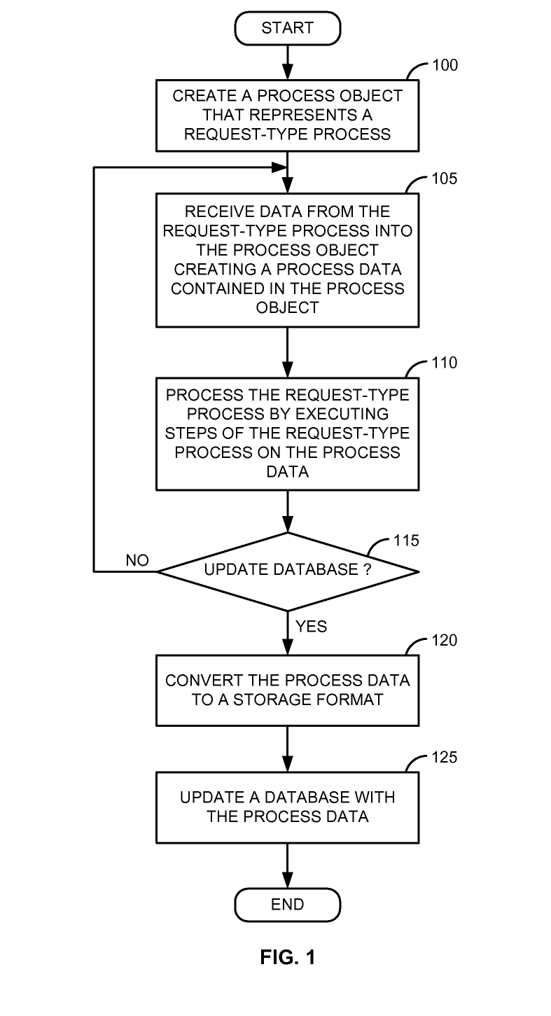

FIG. 1 is a flow diagram for processing a request-type process using a process object framework according to an embodiment of the invention. At step 100, a process object that represents a request-type process of an application is created. At step 105, data from the request-type process is received into the process object to create a process data contained in the process object. At step 110, the request-type process is processed by executing steps of the request-type process on the data contained in the process object. The process data is temporarily stored in the process object. The process object acts as a temporary buffer for the process data.

At decision step 115, a database is checked to determine whether the database must be updated with the process data. If the database must be updated, the process data contained in the process object is converted to a storage format as depicted in step 120 and the database is updated with the process data as depicted in step 125, otherwise the control is transferred to step 105 to receive data from the request-type process. The processing of the request-type process is made more efficient by storing the process data temporarily in the profile object and retrieving the process data from the process object is more efficient and less time consuming than retrieving the process data from the database after every step of the request-type process which is typically very time consuming. Finally, after execution of all steps of the request-type process, the database is updated with the process data contained in the process object as depicted in step 125.

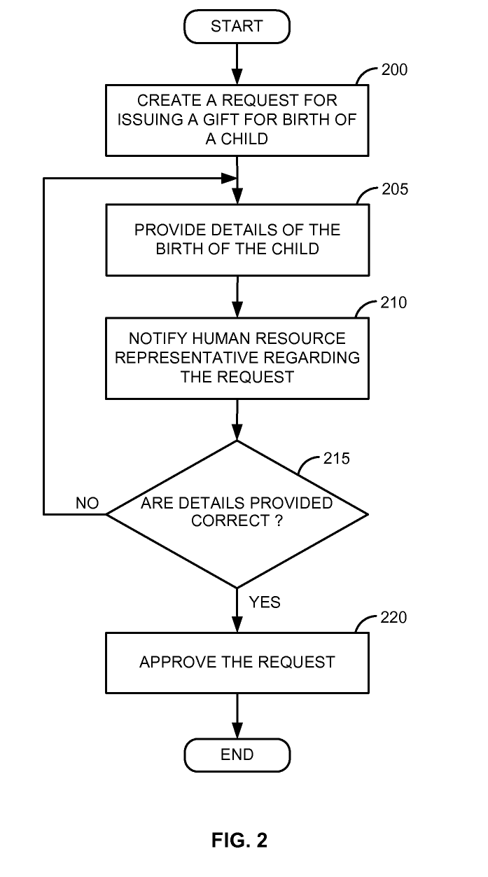

FIG. 2 is a flow diagram for a birth of a child process according to an embodiment of the invention. The birth of a child process is a request-type process where in an employee of an organization notifies a human resource (HR) representative regarding birth of a child, for example, to receive a gift from the organization. The steps of the birth of a child process represent a request, process and approve step of the request-type process. At step 200, the employee creates a request process for issuing the gift for birth of a child. At step 205, details such as a name of the baby, a date of birth of the baby and an attachment of a birth certificate of the baby are provided. At step 210 the HR representative of the organization is notified regarding the request for issuing the gift to the employee for the birth of a child. At decision step 215, the HR representative verifies whether the details provided are correct. The HR representative checks details such as whether the birth certificate has been attached, if the name of the baby and the date of birth of the baby specified are correct. If the details provided are not correct, then the control is transferred to step 205 where the employee is requested to provide the details. For example, if the birth certificate has not been attached, the HR representative rejects the request by adding a comment to submit the birth certificate. If the details provided are correct, then at step 220 the HR representative finally approves the request to issue the gift. On approval, a database is updated with all the necessary details of the child and the employee.

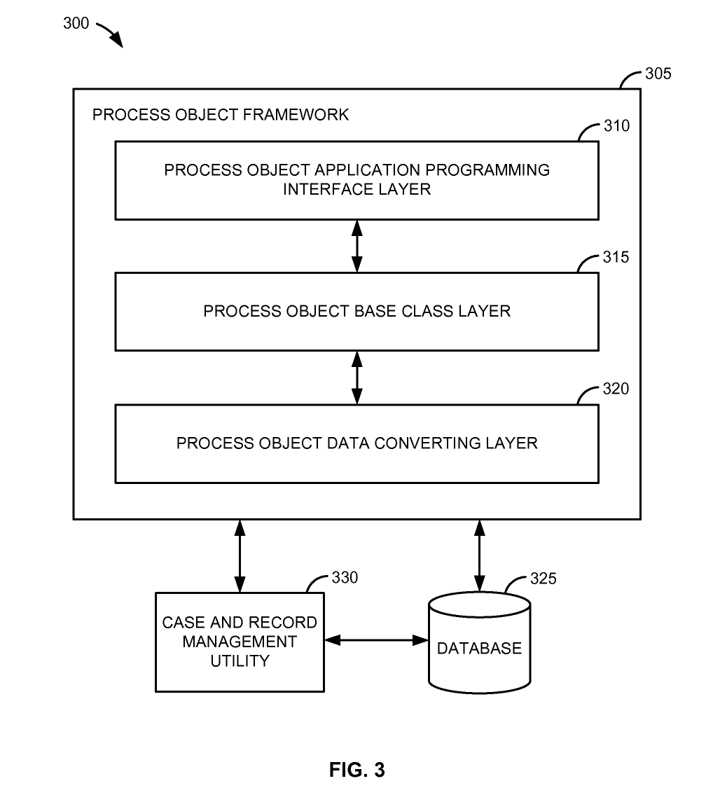

FIG. 3 is a block diagram of various layers of a process object framework according to an embodiment of the invention. System 300 depicts a technical implementation of process object framework 305. Process object framework 305 has various layers such as process object application programming interface (API) layer 310, process object base class layer 315 and process object data converting layer 320.

Process object API layer 310 offers API for functions such as create, get, delete, update, read and query. A user may create a process object representing a request-type process of an application using “CREATE” API. After the process object is created, process object framework 305 identifies the application by issuing an application identifier. The process object also acts as a buffer to store process data received from the request-type process of the application. The process object may perform functions such as creating, updating, and retrieving attributes of the application, the request-type process or a step of the request-type process. All the above functions are performed on the process data stored in the process object.

Process object base class layer 315 provides functions of the request-type process of the application. The user may customize process object base class layer 315 to add new function or modify the function of the request-type process. Process object base class layer 315 is responsible for updating database 325 with the process data contained in the process object. Process object base class layer 315 pushes the process data to database 325 via process object data converting layer 320 on demand. Process object API layer 310 provides a “FLUSH” API that may be used to update database 325.

Process object data converting layer 320 converts the process data to a storage format. When the “FLUSH” API is called to push the process data from the process object to database 325, the process data in the process object is converted to the storage format by process object data converting layer 320 and database 325 is updated with the converted process data. In an embodiment, the process data may be stored in database 325 as a case and record model. Process object data converting layer 320 converts the process data into a format understandable by case and records management utility 330. Case and record management utility 330 will convert the process data into a case and record format and update the process data in database 325 accordingly.

Database 325 may be updated in a synchronous mode and an asynchronous mode. With a synchronous update, a program that outputs a commit statement waits until the update process outputs the status of the update. The control is not passed back to the program until the result of the update process is output. With an asynchronous update, the program that outputs the commit statement passes the update onto the update system and does not wait for the update process to respond. The control is returned back to the program after commit statement has been issued.

Record management of case and record management utility 330 is a solution for an electronic management of records. Quick access to information is a key factor for performing business and record management provides this quick access. In one record, all information objects of a business transaction are grouped together in a transparent hierarchical structure. Converting a paper record to electronic record typically has the advantages of a paper-free office, that is, less storage costs for records, less cost-intensive copying procedures, and optimal retrieval of information. However, record management not only provides an electronic representation of the conventional paper record, but also offers functions such as fast and secure access to archived documents.

The user can enter documents and notes directly in a record, using document. The user may also include internet or intranet pages in the record. In addition to documents, the user can also integrate other electronic elements such as business objects, transactions and reports to provide a universal view of all the information objects that exist for a business process. Access to information is facilitated. The user no longer has to navigate through systems to find information objects, because all the information objects for the whole record are available in one structured view.

Case management of case and record management utility 330 is a component for processing incidents, for example, a customer complaint or a late delivery. The system displays an overview of all the information relating to a case on one screen, and enables electronic forwarding of the case to other users. Because a case typically contains an electronic record, case management is integrated with record management. Case management, typically can be used within many applications. It has an extensive range of customizing functions, which can be used to define the appearance of the screen and the specific functions for the case. The case consists of the following:
Header data: Attributes that contain important data for the case.
Linked objects (electronic record): All information objects that are relevant for the case. These can be documents as well as system objects such as business objects.
Notes: Ongoing notes are entered by processors of the case.
Process route: Sequence of users who receive the case for processing.
Log: List of all activities that have been performed on the case.

Storing and retrieving process data from database 325 as a case and record model may consume a significant amount of time and resources such as CPU time and memory is consumed. To make the processing of the request-type process more efficient, the data received from the request-type process is stored temporarily in the process object rather than as a case and record format in database 325. Further, the process object executes all steps of the request-type process on the process data stored in the process object and not on the process data in database 325. Typically, after execution of all the steps of the request-type process, the process data is finally stored in database 325 in the case and record model format. By storing and processing the process data in the process object, the execution of the request-type process is made more efficient by minimizing consumption of time and memory.

Process object framework 305 facilitates a request-type process such as the birth of child process described in FIG. 2. Process object API layer 310 provides the API to create a process object representing the request-type process such as the birth of child process. Process object base class layer 315 facilitates executing steps of the birth of child process such as receiving the request from the employee, processing the request by the HR representative and approval of the request by the HR representative. The process data such as a name of the employee, a name of the child, a date of birth of the child, and the attachment such as birth certificate are temporarily stored in the process object. Apart from the process data, process specific attributes and application specific attributes such as a created by name, a created by date, a status pf the process, and a status of the application are stored in the process object. The process object executes all steps of the request-type process on the process data in the process object. After the final approval of the request by the HR representative, the process data contained in the process object is pushed to database 325. Process object data converting layer 320 converts the process data to a storage format and database 325 is updated with the process data. In an embodiment, the process data of the birth of the child process is stored in a case and record model format via case and record management utility 330.

In the birth of child request-type process described in FIG. 2, process object framework 305 makes the process more efficient by storing and retrieving the process data from the process object rather than database 325 which is more time consuming and resource occupying. Storing and retrieving the process data from the process object has significant effect on time required to store or retrieve process data since the process data is accessed multiple times in the process. First, the process data is written into the process object when the employee provides details of the birth of child process in step 205 in FIG. 2. Second, the process data is fetched from the process object by the HR representative when the HR representative verifies if the details provided are correct in step 215. If all the necessary details are not specified, the employee writes the necessary details again into the process object and the HR representative would retrieve the process data again. A significant amount of time may be consumed if the process data was written and retrieved from database 325 in every step. Instead, process object framework 305 stores the process data in the process object and all steps are executed on the process data contained in the process object. Process object framework 305 would push the process data to database 325 only as necessary. In an embodiment, the process data may be pushed to database after the final step of the request-type process such as the HR representative approval of the request. Also, the process object enables the user to customize the functionality of the birth of the child process by providing an API in process object base class layer 315.

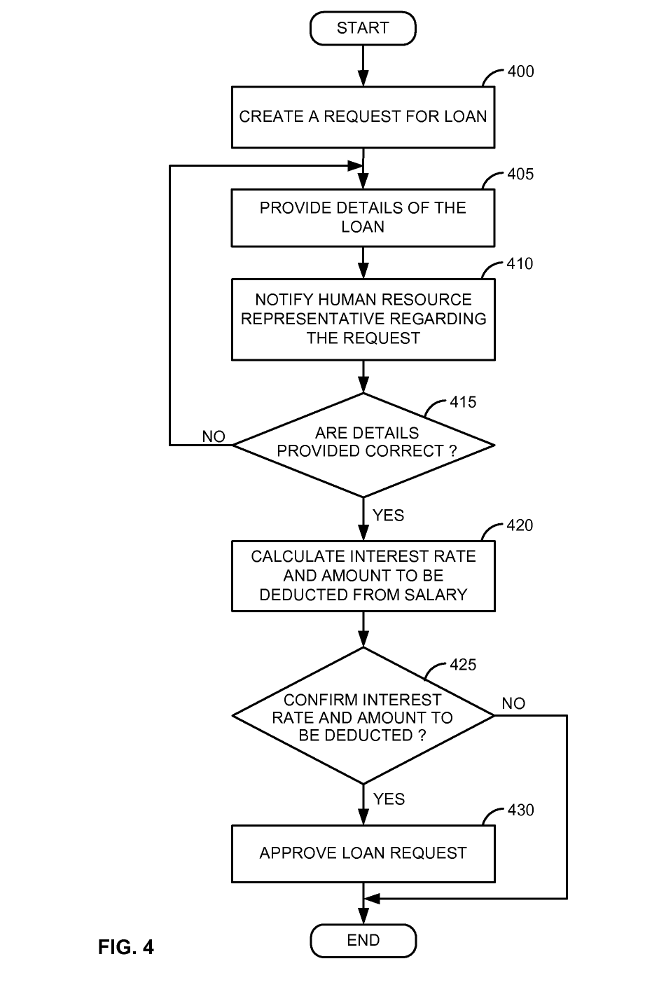

FIG. 4 is a flow diagram for an employee loan application process according to an embodiment of the invention. An employee loan application process is a request-process-approve type process. At step 400, an employee creates a request for a loan by initiating a loan application process. The loan application process presents the employee with a loan application user interface (UI). At step 405, the employee provides details of the loan such as a loan amount required, a loan required by date, a purpose of loan, and attaches necessary documents as a proof for the purpose requested in the UI. At step 410, a process step, a HR representative is notified regarding the request for loan. At decision step 415, the HR representative verifies the details provided to determine if the details provided are correct. The details verified include details such as whether an employee is eligible for the requested loan amount, and whether the employee has any outstanding loan. If the details provided are correct, at step 420, an interest rate for the loan and an amount to be deducted from a monthly salary to recover the loan would be calculated. At decision step 425, the employee confirms whether the interest rate and the amount to be deducted from monthly salary are acceptable. If the employee confirms, at step 430 the HR representative finally approves the employee loan request.

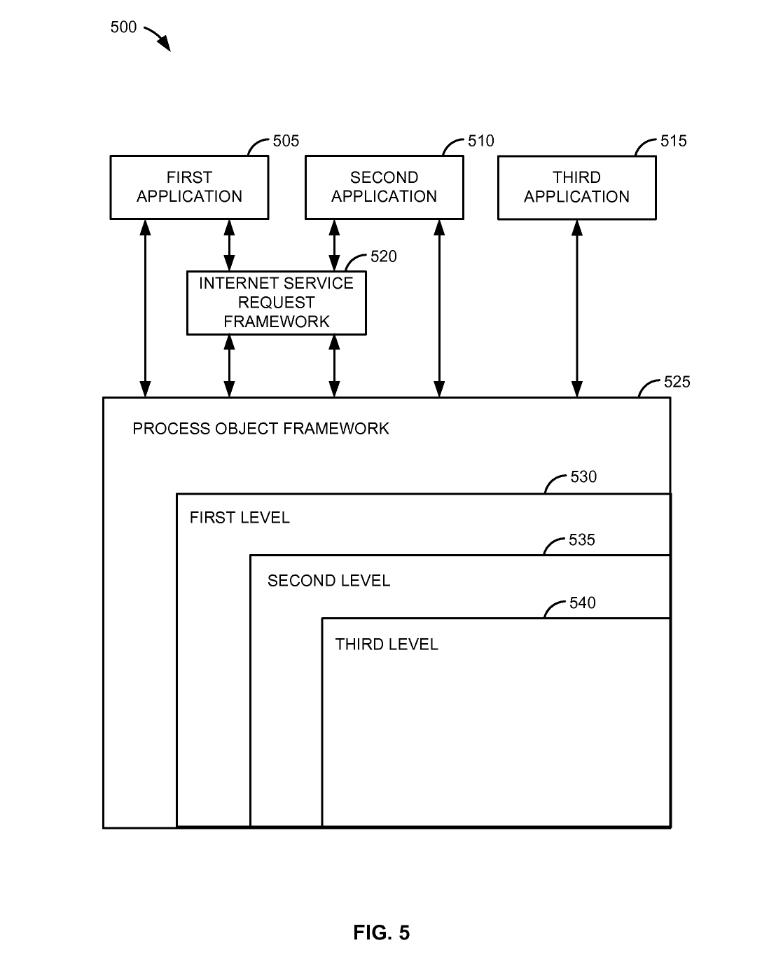

FIG. 5 is a block diagram for integrating request-type process of applications using a process object framework according to an embodiment of the invention. System 500 depicts integration of first application 505, second application 510 and third application 515 via process object framework 525. First application 505 such as HR administration may interact with second application 510 such as employee interaction center (EIC) via internet service request framework 520. Internet service request framework 520 enables an application to be accessed via web based browsers. The integration between applications is represented by a link identification number maintained in process object framework database tables. The integration between applications enables a business scenario to be performed more efficiently. For example, in the birth of the child process described in FIG. 2, an EIC representative may raise a request for the birth of child on behalf of the employee. The EIC is a scenario where an employee calls the EIC representative with a problem. The EIC representative logs the problem and tries to co-ordinate with concerned department to provide a solution to the problem of the employee.

Process object framework 525 provides various levels of storage of process data. In an embodiment, process object framework 525 provides three levels such as, first level 530, second level 535 and third level 540 to store the process data hierarchically. In an embodiment, first level 530 is mandatory to be implemented, that is, a user typically has to use first level 530 to store the process data. Second level 535 and third level 540 are optional, that is, the user may choose not to use second level 535 and third level 540 to store the process data. At each level, an application can define application attributes. The attributes include step specific attributes, process specific attributes and application specific attributes. Process object framework 525 allows the process data at different levels to be linked to each other. Process object framework 525 also allows an application to define a case and record model that represents a structure of a linked object to the case model at each level. Various types of objects that may be linked are attachment such as a birth certificate of a person, a data container such as XML string that contains structured data, a business object repository and various attributes related to the above objects such as a created by name and a created by date. Process object framework 525 also allows tracking of changes made to the process data. The user may obtain information such as the change in the process data, the time at which the process data was changed and the user who changed the process data.

Process object framework 525 enables hierarchical storage of a process data created in the employee loan application process described in FIG. 4. The process data is stored hierarchically in the three levels. First level 530 typically contains the process data such as a name of the process, a status of the process, a created by name, a start date of the process and a completed by date of the process which form part of process specific attributes. Second level 535 typically contains process data such as a name of the loan application UI, an attribute specifying whether the process data in the UI is persisted or not, a created date and time, a last modified date, and an approved by name which form part of step specific attributes. Third level 540 would contain process data such as details entered by the employee in the loan application UI, the attachments uploaded with the loan application UI, and a status of each of the steps of the process. Maintaining the process data hierarchically in process object framework 525 enables the process data to be managed efficiently, especially with respect to storing and retrieving the process data from a database.

Process object framework 525 enhances the performance of a request-type process by following mechanisms:
Process object framework 525 maintains process data such as attributes, attachments, containers and a level-to-level linked object information as a cache in a process object. All operations such as create, update, delete are performed only on the process data in the process object, unless the “FLUSH” API is called. In an embodiment, the case management is delayed and only on-demand, the process data is pushed to the database; thereby decreasing the time required to store and retrieve the process data.
Process object framework 525 maintains relationships across different levels in process object framework database tables which enable a fast access of the linked objects.
Attributes of the process are stored in database tables of process object framework 525 in order to avoid storing and retrieving process data from database for read and search operations.
Supports both modes of update of process data to the database such as synchronous and asynchronous.

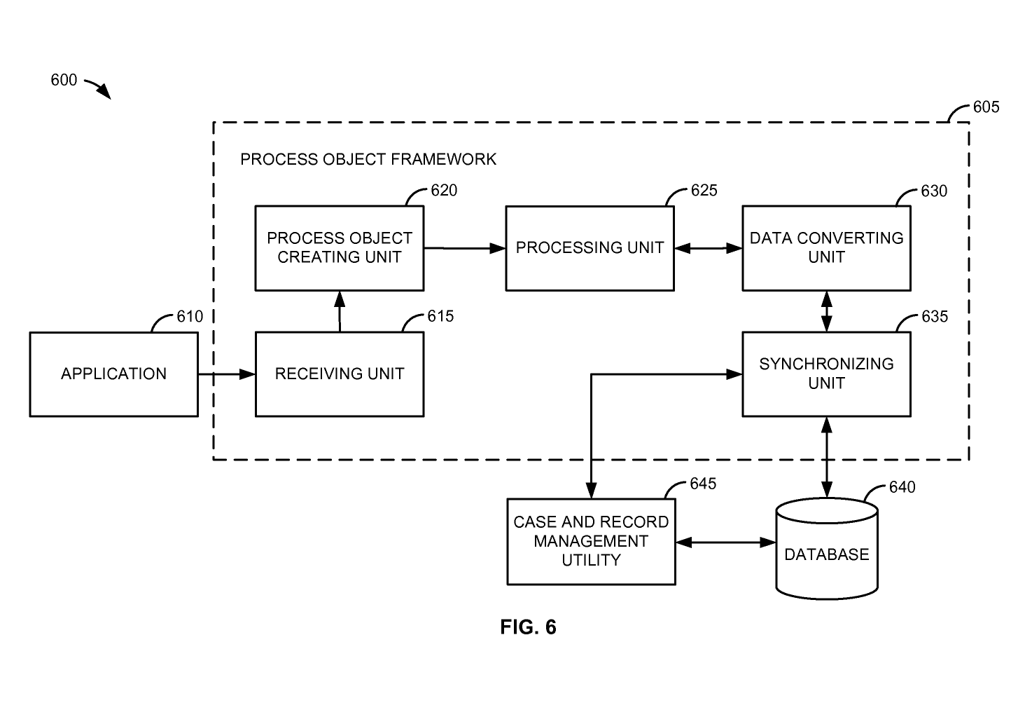

FIG. 6 is a block diagram of various components of a process object framework for processing a request-type process of an application according to an embodiment of the invention. System 600 contains a process object framework 605 that processes a request-type process of application 610. Receiving unit 615 receives process data from the request-type process of application 610 into a process object created by process object creating unit 620. The process object represents the request-type process of application 610. The process object contains the functionality of the request-type process. Application 610 is identified by an application identifier in the process object.

Processing unit 625 processes the request-type process of application 610 by executing steps of the request-type process on the process data contained in the process object. Data converting unit 630 converts the process data into a storage format. Synchronizing unit 635 updates database 640 with the process data received from data converting unit 630. Synchronizing unit 635 updates database 640 in both modes such as a synchronous mode and an asynchronous mode. In an embodiment, the process data is stored in database 640 in a case and record format via case and record management utility 645.

Embodiments of the invention may include various steps as set forth above. The steps may be embodied in machine-executable program code which causes a general-purpose or special-purpose processor to perform certain steps. Alternatively, these steps may be performed by specific hardware components that contain hardwired logic for performing the steps, or by any combination of programmed computer components and custom hardware components.

Embodiments of the present invention may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cards, propagation media or any other type of machine-readable media suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Throughout the foregoing description, for the purposes of explanation, numerous specific details were set forth in order to provide a thorough understanding of the invention. It will be apparent, however, to one skilled in the art that the invention may be practiced without some of these specific details. Accordingly, the scope and spirit of the invention should be judged in terms of the claims which follow.

What is claimed is:

1. A method, comprising:
creating a process object representing a request-type process of a first application;
receiving data from the request-type process into the process object creating a process data contained in the process object;
processing the request-type process by executing steps of the request-type process on the process data;
converting the process data to a storage format; and
updating a database with the process data.

2. The method in claim 1, wherein processing the request-type process comprises persisting the process data in the process object and retrieving the process data from the process object.

3. The method in claim 2, wherein persisting the process data comprises persisting the process data in a hierarchical way.

4. The method in claim 2, wherein the process data comprises data selected from a group consisting of an attachment, a data container, a business object repository, and a status transition attribute.

5. The method in claim 1, wherein processing the request-type process comprises searching an attribute of the process data.

6. The method in claim 1, further comprising integrating the first application with a second application by maintaining a link between the first application and the second application in a process object framework database table.

7. The method in claim 1, further comprising providing an application programming interface that enables customizing the processing of the process data.

8. The method in claim 1, further comprising identifying the first application by an application identification number.

9. The method in claim 1, wherein converting the process data comprises converting the process data to a case and record format persisted in the database by a case and record management utility.

10. The method in claim 1, wherein updating the database comprises updating the database in a synchronous mode and an asynchronous mode.

11. A system, comprising:
a process object creating unit to create a process object that represents a request-type process of a first application;
a receiving unit electronically coupled to the process object creating unit to receive data from the request-type process into the process object creating a process data contained in the process object;
a processing unit electronically coupled to the receiving unit to process the request-type process by executing steps of the request-type process on the process data;
a data converting unit electronically coupled to the processing unit to convert the process data to a storage format; and
a synchronizing unit electronically coupled to the data converting unit to update a database with the process data.

12. The system in claim 11, further comprising a process object framework database electronically coupled to the processing unit to maintain a relationship between the first application and a second application.

13. The system in claim 11, wherein the processing unit comprises an application programming interface to enable customizing processing of the process data.

14. The system in claim 11, further comprising a case and record management utility electronically coupled to the synchronizing unit to persist the process data in a case and record format.

15. An article of manufacture, comprising:
a machine readable medium having instructions which when executed by a machine cause the machine to:
create a process object representing a request-type process of a first application;
receive data from the request-type process into the process object creating a process data contained in the process object;
process the request-type process by executing steps of the request-type process on the process data;
convert the process data to a storage format; and
update a database with the process data.

16. The article of manufacture in claim 15, wherein the machine readable medium provides instructions, which when executed by a machine cause the machine to identify the first application by an application identification number.

17. The article of manufacture in claim 15, wherein the machine readable medium provides instructions, which when executed by a machine cause the machine to provide an application programming interface that enables customizing the processing of the process data.

18. The article of manufacture in claim 15, wherein the machine readable medium provides instructions, which when executed by a machine cause the machine to update the database in a synchronous mode and an asynchronous mode.

19. The article of manufacture in claim 15, wherein the machine readable medium provides instructions, which when executed by a machine cause the machine to persist the process data in the process object and retrieve the process data from the process object.

20. The article of manufacture in claim 19, wherein the machine readable medium provides instructions, which when executed by a machine cause the machine to persist the process data in the process object in a hierarchical way.
